(19) United States
(12) Patent Application Publication
(10) Pub. No.: US 2025/0144461 A1
(43) Pub. Date: May 8, 2025

(54) FIRE-FIGHTING FOAM COMPOSITION

(71) Applicant: Tyco Fire Products LP, Cranston, RI (US)

(72) Inventors: JoAnna Marie Monfils, Peshtigo, WI (US); Alec VandenHeuvel, Denmark, WI (US); Margaret Roselyn Faccio, Green Bay, WI (US)

(73) Assignee: Tyco Fire Products LP, Cranston, RI (US)

(21) Appl. No.: 18/933,855

(22) Filed: Oct. 31, 2024

Related U.S. Application Data
(60) Provisional application No. 63/595,403, filed on Nov. 2, 2023.

(51) Int. Cl. A62D 1/02; A62C 99/00

(52) U.S. Cl. CPC A62D 1/0071; A62C 99/0036

(57) ABSTRACT

An aqueous fluorine-free, fire-fighting composition including a sugar component, an anionic surfactant, a zwitterionic surfactant, water-miscible organic solvent, and a nonionic surfactant, is provided.

### CROSS-REFERENCE TO RELATED APPLICATIONS

This application claims the benefit of priority to U.S. Provisional Patent Application No. 63/595,403, filed on Nov. 2, 2023, the contents of which are incorporated herein by reference in their entirety.

### BACKGROUND

Firefighting foams are often deployed to suppress or extinguish Class B fires. Class B fires are those involving flammable liquid fuels, gasoline, and other hydrocarbons and are difficult to extinguish. Most flammable liquids exhibit high vapor pressure along with low fire and flash points. This typically results in a wide flammability range. In this type of fire, the use of water as the sole firefighting agent is generally ineffective because the only means of fighting fire with water is through cooling and the hydrophobic nature of the liquids involved may result in the water spreading the fuel around rather than extinguishing the fire.

Conventional foam-forming firefighting compositions commonly include fluorinated and perfluorinated surfactants. Environmental concerns related to fluorinated and perfluorinated surfactants have developed. As a result, there is a strong desire in the marketplace to replace fluorinated and perfluorinated firefighting products with non-fluorinated products. There is therefore a continuing need to produce fluorine-free AFFF firefighting compositions that can be deployed to effectively fight and suppress Class B fires.

### SUMMARY

The present application is directed to aqueous fire-fighting compositions, typically in the form of foam concentrates, which can be diluted with an aqueous diluent to provide a foam precursor composition. The diluted foam precursor composition can be aerated to form a firefighting foam, which may be used to suppress vapors and/or fight a fire. The compositions may be particularly advantageous for use in forming foam to fight and/or suppress hydrocarbon or volatile solvent fires (e.g., Class B fires). The aqueous fire-fighting composition may include a sugar component; a surfactant component comprising an anionic surfactant, a zwitterionic surfactant, and/or a nonionic surfactant; and a water-miscible organic solvent.

In one aspect, an aqueous fluorine-free, fire-fighting foam composition is provided, which includes a sugar component comprising a monosaccharide sugar, a disaccharide sugar, and/or a sugar alcohol; a nonionic surfactant comprising an alkyl polyglycoside and/or an aliphatic alcohol, optionally a second surfactant component comprising an anionic surfactant, a zwitterionic surfactant, or a mixture of two or more thereof; and a water-miscible organic solvent (e.g., a glycol and/or glycol ether solvent). In some embodiments, such a composition is substantially free of, and in many instances does not contain, a polysaccharide thickener.

In an embodiment, the sugar component includes glucose, fructose, mannose, xylose, sucrose, lactose, maltose, lactulose, trehalose, cellobiose, chitobiose, xylitol, sorbitol, mannitol, or a mixture of any two or more thereof. In an embodiment, the aqueous fluorine-free, fire-fighting foam composition includes at least about 5 wt. % of the sugar component. In some embodiments, the aqueous fluorine-free, fire-fighting foam composition includes about 5 to 25 wt. % of the sugar component.

In an embodiment, the anionic surfactant may include one or more of an aliphatic sulfate surfactant, an aliphatic sulfonate surfactant, an aliphatic succinate salt, and an aliphatic ether sulfate surfactant. In one embodiment, the anionic surfactant includes one or more of C₈-C₁₄ alkyl sulfate, C₈-C₁₄ alkyl sulfonate and C₁₀-C₁₄ alkyl ether sulfate. In some embodiments, the anionic surfactant includes one or more C₈-C₁₄ alkyl sulfates. In some embodiments, the anionic surfactant includes a decyl sulfate salt and/or a lauryl sulfate salt. In some embodiments, the composition includes about 3 to 25 wt. % of the anionic surfactant.

In some embodiments, the zwitterionic surfactant may include one or more of an aliphatic amidoalkyl betaine, an aliphatic sulfobetaine, an aliphatic amidoalkyl hydroxysultaine, and an aliphatic hydroxysultaine. In some embodiments, the zwitterionic surfactant includes an aliphatic amidoalkyl hydroxysultaine, such as an alkyl amidoalkyl hydroxysultaine. In some embodiments, the zwitterionic surfactant includes one or more C₈-C₁₄ alkyl amidopropyl hydroxysultaines. In some embodiments, the composition includes about 2 to 15 wt. % of the zwitterionic surfactant.

In some embodiments, the nonionic surfactant comprises an alkyl polyglucoside, an aliphatic alcohol, or a mixture of any two or more thereof. In some embodiments, the composition comprises about 2 to 15 wt. % of the nonionic surfactant.

In some embodiments, the water-miscible organic solvent includes an alkylene glycol, an alkylene glycol monoalkyl ether, or a mixture of two or more thereof. In some embodiments, the water-miscible organic solvent includes ethylene glycol, diethylene glycol monobutyl ether, glycerin, or a mixture of two or more thereof. In some embodiments, the composition includes about 1 to 30 wt. % of the water-miscible organic solvent. In some embodiments, the water-miscible organic solvent includes one or more of diethylene glycol monobutyl ether, ethylene glycol monophenyl ether, dipropylene glycol monobutyl ether, dipropylene glycol monomethyl ether, 1,6-hexanediol, ethylene glycol, hexylene glycol, propylene glycol, and glycerin.

In an aspect, provided is an aqueous fluorine-free, fire-fighting foam composition comprising: about 5 to 25 wt. % of a sugar component comprising a monosaccharide sugar, a disaccharide sugar, a sugar alcohol, or a mixture of two or more thereof; about 5 to 25 wt. % of an anionic surfactant; about 2 to 15 wt. % of the zwitterionic surfactant; about 1 to 30 wt. % of a water-miscible organic solvent; and about 2 to 15 wt. % of a nonionic surfactant comprising an alkyl polyglycoside, an aliphatic alcohol, or a mixture of any two or more thereof; where the composition is substantially free of a polysaccharide thickener.

In any of the above embodiments, the fire-fighting foam composition may include a total of no more than about 0.01 wt. % of a polysaccharide thickener.

In an aspect, provided is an aqueous fluorine-free, fire-fighting foam composition, which includes a sugar component comprising a monosaccharide sugar, a disaccharide sugar, and/or a sugar alcohol; a surfactant component comprising an anionic surfactant, a zwitterionic surfactant, a nonionic surfactant, or a mixture of two or more thereof, wherein the nonionic surfactant comprises an alkyl polyglycoside and/or an aliphatic alcohol; a water-miscible organic solvent (e.g., a glycol and/or glycol ether solvent); and a thickener. In some embodiments, the aqueous fluorine-free, fire-fighting foam composition is free of diutan gum.

In an aspect, provided is an aqueous fluorine-free, fire-fighting foam composition comprising: about 5 to 25 wt. % of a sugar component comprising a monosaccharide sugar, a disaccharide sugar, a sugar alcohol, or a mixture of two or more thereof; about 5 to 25 wt. % of an anionic surfactant; about 2 to 15 wt. % of the zwitterionic surfactant; about 1 to 30 wt. % of a water-miscible organic solvent; about 2 to 15 wt. % of a nonionic surfactant comprising an alkyl polyglycoside, an aliphatic alcohol, or a mixture of any two or more thereof; and about 0.1 to 5 wt. % of a thickener.

In some embodiments, the thickener comprises agar, sodium alginate, propylene glycol alginate, pectin, carrageenan, collagen, gelatin, sodium acrylate, xanthan gum, guar gum, tara gum, acacia gum, karaya gum, pullulan gum, locust bean gum, welan gum, rhamsam gum, chicle gum, kino gum, dammar gum, mastic gum, spruce gum, gellan gum, cassia gum, fenugreek gum, ghatti gum, konjac gum, gum arabic, gum guaicum, neem gum, gum tragacanth, gum chatti, tamarind seed, tapioca starch, cassava root powder, Pistacia lentiscus, caranna, galactomannan, beta-glucan, cellulose, methylcellulose, glucomannan, succinoglycan, hydroxyethylcellulose, hydroxypropylmethylcellulose, or a mixture of any two or more thereof. In some embodiments, the thickener comprises xanthan gum, tamarind seed, tapioca starch, cassava root powder, guar gum, tara gum, acacia gum, karaya gum, pullulan gum, sodium alginate, propylene glycol alginate, pectin, locust bean gum, carrageenan, collagen, gelatin, sodium acrylate, or a mixture of any two or more thereof. In some embodiments, the thickener is not diutan gum.

In any of the above embodiments, the fire-fighting foam composition may further include an alkanolamine, such as monoethanolamine, diethanolamine, diisopropanolamine, and/or triethanolamine. In some embodiments, where the fire-fighting foam composition includes an alkanolamine, it may advantageously include triethanolamine. In some embodiments, the composition includes about 1 to 10 wt. % of the alkanolamine.

In any of the above embodiments, the fire-fighting foam composition may further include a metallic salt, such as a magnesium salt or a potassium salt. In some embodiments, the metallic salt includes magnesium sulfate, although other suitable magnesium salts, e.g., magnesium acetate, may be utilized. In some embodiments, the metallic salt includes potassium bicarbonate. In some embodiments, the composition includes about 0.2 to 3 wt. % of the metallic salt.

In any of the above embodiments, the fire-fighting foam composition may also include one or more of a chelator, a buffer, a corrosion inhibitor, and a preservative.

In any of the above embodiments, the fire-fighting foam composition may have a pH of about 6.5 to 8.

In any of the above embodiments, the fire-fighting foam composition may have no more than about 0.01% wt. % fluorinated additives.

In any of the above embodiments, the fire-fighting foam composition may have a fluorine content of no more than about 1 ppm F.

In any of the above embodiments, the fire-fighting foam composition may include at least about 30 wt. % water.

In another aspect, a method of forming a firefighting foam includes aerating any one of the aqueous fluorine-free, fire-fighting foam compositions described herein to form the firefighting foam.

In another aspect, a method of forming a firefighting foam includes mixing any one of the aqueous fluorine-free, fire-fighting foam compositions described herein with an aqueous diluent to form a foam precursor solution, and aerating the foam precursor solution to form the firefighting foam.

In some embodiments, the aqueous diluent is selected from the group consisting of fresh water, brackish water, sea water, and a combination of any two or more thereof.

In some embodiments, the aqueous diluent comprises water from a municipal water source.

In yet another aspect, a fire-fighting foam is provided, the fire-fighting foam including any one of the aqueous fluorine-free, fire-fighting foam compositions described herein and an aqueous diluent.

In another aspect, a method of fighting a fire is provided, the method including applying any one of the aqueous fluorine-free, fire-fighting foam compositions described herein to the fire.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In one aspect, the aqueous fluorine-free, fire-fighting foam compositions of the present disclosure include a sugar component comprising a monosaccharide sugar, a disaccharide sugar, a sugar alcohol, or a mixture of any two or more thereof; a surfactant component comprising an anionic surfactant, a zwitterionic surfactant, a nonionic surfactant, or a mixture of two or more thereof, wherein the nonionic surfactant comprises an alkyl polyglycoside and/or an aliphatic alcohol; and a water-miscible organic solvent. Such compositions are generally substantially free of a polysaccharide thickener.

In another aspect, the aqueous fluorine-free, fire-fighting foam composition, includes a sugar component comprising a monosaccharide sugar, a disaccharide sugar, and/or a sugar alcohol; a surfactant component comprising an anionic surfactant, a zwitterionic surfactant, a nonionic surfactant, or a mixture of two or more thereof, wherein the nonionic surfactant comprises an alkyl polyglycoside and/or an aliphatic alcohol; a water-miscible organic solvent (e.g., a glycol and/or glycol ether solvent); and a thickener, wherein the thickener is not diutan gum.

Saccharides for use in the present aqueous fire-fighting compositions are generally simple monosaccharide sugars and may include other carbohydrates, such as common sugar (sucrose/dextrose) derived from sugar cane or sugar beets. Sucrose is a disaccharide composed from the basic, simple sugar molecules glucose and fructose. Mixtures where the majority of the sucrose has been broken down into its monosaccharide components, glucose and fructose (e.g., invert sugar), are quite suitable for use in the present compositions. Sucrose is readily available in view of its world production from cane and sugar beet on the order of millions of tons per annum. Those skilled in the art will also be aware that other commercially available simple monosaccharides and related sugar alcohols can be utilized in the present compositions. Examples of suitable monosaccharides for use in the present compositions include one or more of glucose, fructose, mannose, xylose and galactose. Examples of suitable disaccharides for use in the present foam compositions include one or more of sucrose, lactose, maltose, trehalose, lactulose, cellobiose, and chitobiose. Examples of suitable sugar alcohols for use in the present compositions include one or more of a four carbon sugar alcohol, such as erythritol, a five carbon alditol, such as xylitol, a six carbon alditol, such as mannitol and/or sorbitol, and other sugar alcohols, such as isomalt. In some embodiments, the sugar alcohol is one derived from a monosaccharide.

The present aqueous fluorine-free, fire-fighting foam compositions include a sugar component comprising a monosaccharide sugar, a disaccharide sugar, and/or a sugar alcohol. Suitable examples include a sugar component containing one or more of glucose, fructose, mannose, sucrose, lactose, maltose, trehalose, lactulose, cellobiose, chitobiose, xylose, sorbitol, xylitol and mannitol. The composition includes about 5 to 25 wt. % of the sugar component. In some embodiments, the composition includes about 10 to 20 wt. % of the sugar component.

In some embodiments, the present aqueous fire-fighting foam compositions include an anionic surfactant. Illustrative anionic surfactants include an alkyl sulfate surfactant, an alkyl sulfonate surfactant, alkyl ether sulfate surfactant, an alkyl ether sulfonate surfactant, or a mixture of any two or more thereof. In some embodiments, the anionic surfactant may include an alkyl sulfate surfactant and/or an alkyl sulfonate surfactant. In some embodiments, the alkyl sulfate salt surfactant includes a C₈₋₁₂-alkyl sulfate salt. Non-limiting examples of the C₈₋₁₂-alkyl sulfate salt include a dodecyl sulfate salt, a decyl sulfate salt, an octyl sulfate salt, or a mixture of any two or more thereof. In some embodiments, the alkyl sulfate salt includes an alkyl sulfate sodium salt, such as a sodium decyl sulfate, sodium octyl sulfate, or a mixture of any two or more thereof. In some embodiments, the alkyl sulfate salt includes an alkyl sulfate ammonium salt, such as an ammonium decyl sulfate, ammonium octyl sulfate, ammonium lauryl sulfate, or a mixture of any two or more thereof. In some embodiments, the anionic surfactant includes a C₈₋₁₄-alkyl sulfate salt and/or a C₈₋₁₄-alkyl sulfonate salt. In some embodiments, the firefighting composition further includes an anionic surfactant, which comprises one or more surfactants selected from C₈₋₁₂-alkyl sulfate salts and/or a C₈₋₁₂-alkyl sulfonate salts. As a non-limiting example, one or more of octyl sulfate salts, decyl sulfate salts, dodecyl sulfate salts and tetradecyl sulfate salts may be used as anionic surfactants in the present firefighting compositions. The anionic surfactant may be a sodium, potassium and/or ammonium salt. In some embodiments, the aqueous firefighting foam compositions may include about 2 to 25 wt. % of the anionic surfactant. In some embodiments, the aqueous firefighting foam composition includes about 2 to 20 wt. %, or about 6 to 20 wt. % of the anionic surfactant.

In some embodiments, the present aqueous fire-fighting foam compositions include a zwitterionic surfactant. Illustrative zwitterionic surfactants include an alkylamidoalkyl betaine surfactant, an alkyl betaine surfactant, an alkyl sulfobetaine surfactant, an alkylamidoalkylene hydroxysultaine surfactant, such as an alkylamidopropyl hydroxysultaine surfactant, or a mixture of two or more thereof. As a non-limiting example, the firefighting composition includes a zwitterionic surfactant, which comprises one or more of a C₈₋₁₈-alkylamidopropyl hydroxysultaine surfactant, a C₈₋₁₈-alkylamidopropyl betaine surfactant, a C₈₋₁₈-alkyl sulfobetaine surfactant, a C₈₋₁₈-alkyl betaine surfactant, or a mixture of two or more thereof. Non-limiting examples of the alkylamidoalkylene hydroxysultaine surfactant include a C₈₋₁₈-alkylamidopropyl hydroxysultaine surfactant, such as a cocamidopropyl hydroxysultaine surfactant, which includes a laurylamidopropyl hydroxysultaine and a myristylamidopropyl hydroxysultaine. Non-limiting examples of the alkylamidoalkyl betaine surfactant include a C₈₋₁₈-alkylamidoalkyl betaine surfactant, such as a cocamidopropyl betaine, a tallowamidopropyl betaine, a laurylamidopropyl betaine or a myristylamidopropyl betaine. In some embodiments, the zwitterionic surfactant includes a C₈₋₁₄-alkylamidopropyl hydroxysultaine, such as a cocamidopropyl hydroxysultaine. In some embodiments, the zwitterionic surfactant includes laurylamidopropyl hydroxysultaine and/or myristylamidopropyl hydroxysultaine. In some embodiments, the aqueous firefighting foam composition includes about 2 to 15 wt. % of the zwitterionic surfactant. In some embodiments, the aqueous firefighting foam composition includes about 5 to 15 wt. % of the zwitterionic surfactant.

Illustrative non-ionic surfactants include an alkyl polyglycoside, an aliphatic alcohol-based nonionic surfactant, or a mixture thereof. In some embodiments, the non-ionic surfactant comprises an alkyl polyglucoside, an aliphatic alcohol, an aliphatic alcohol ethoxylate, or a mixture of two or more thereof. A suitable alkyl polyglucoside for use as a non-ionic surfactant includes a C₈₋₁₆ alkyl polyglucoside. In some embodiments, the alkyl polyglucoside is a C₈-alkyl polyglucoside. As a non-limiting example, the fire-fighting compositions may include an aliphatic alcohol-based nonionic surfactant including an aliphatic alcohol having 8 to 14 carbon atoms and/or an aliphatic alcohol ethoxylate having 10 to 16 carbon atoms in its alcohol portion. The aliphatic alcohol ethoxylate may has an average degree of polymerization (i.e., the average number of ethylene oxide units) of about 0.7-2.0 and often of no more than about 1.5, no more than about 1.2, or no more than about 1.0. Aliphatic alcohols, which include a linear C₈₋₁₄-aliphatic alcohol, such as a C₈₋₁₄-fatty alcohol, may be used as a nonionic surfactant in the present firefighting compositions. Non-limiting examples of such alcohols include one or more of octyl alcohol, decyl alcohol, lauryl alcohol and myristyl alcohol. The firefighting composition may include an aliphatic alcohol ethoxylate having an average of no more than about 2 ethylene oxide units. In some embodiments, the aliphatic alcohol portion of such ethoxylates has about 10 to 16 carbon atoms. Non-limiting examples include decyl alcohol ethoxylates, lauryl alcohol ethoxylates and/or myristyl alcohol ethoxylates. In some embodiments, the alcohol ethoxylates have an average of no more than about 2 ethylene oxide units, no more than about 1.5 ethylene oxide units, no more than about 1.2 ethylene oxide units and, in some instances, no more than about 1 ethylene oxide units. In some embodiments, the aliphatic alcohol ethoxylate comprises an ethoxylate of a linear C₈₋₁₄-aliphatic alcohol having no more than about 1.2 ethylene oxide units.

In some embodiments, the aqueous fluorine-free, fire-fighting foam composition includes about 1 to 15 wt %, about 1 to 10 wt %, about 3 to 10 wt %, or about 5 to 10 wt % of the non-ionic surfactant. In some embodiments, the aqueous fire-fighting foam compositions include about 1 wt %, about 3 wt %, about 5 wt %, about 10 wt %, or about 15 wt % of the non-ionic surfactant.

The present aqueous fire-fighting foam compositions may include an organic solvent, which may suitably include one or more of a glycol, a glycol ether, glycerin (i.e., glycerol) and a water-soluble polyethylene glycol. Examples of suitable organic solvents include diethylene glycol n-butyl ether, dipropylene glycol n-propyl ether, hexylene glycol, ethylene glycol, propylene glycol, diethylene glycol, dipropylene glycol, tripropylene glycol, dipropylene glycol monobutyl ether, dipropylene glycol monomethyl ether, diethylene glycol monobutyl ether, ethylene glycol monobutyl ether, tripropylene glycol monomethyl ether, dipropylene glycol monoethyl ether, glycerol, and mixtures of two or more thereof. In some embodiments, the organic solvent includes a mixture of an alkylene glycol and a glycol ether, such as a glycol butyl ether. In some embodiments, the organic solvent includes an alkylene glycol ether, such as ethylene glycol monoalkyl ether, propylene glycol monoalkyl ether, dipropylene glycol monoalkyl ether, and/or diethylene glycol monoalkyl ether. In some embodiments, the organic solvent includes an alkylene glycol, such as ethylene glycol, propylene glycol, dipropylene glycol and/or diethylene glycol. In some embodiments, the organic solvent may include a mixture of a glycol ether, such as diethylene glycol monobutyl ether, and a glycol, such as ethylene glycol and/or propylene glycol. For example, the organic solvent can include ethylene glycol and diethylene glycol monobutyl ether. In another suitable example, the organic solvent includes propylene glycol and diethylene glycol monobutyl ether.

The foam compositions may include about 0.5 to about 30 wt. % of the organic solvent. In some embodiments, the foam compositions include about 1 to about 30 wt. %, about 1 to about 15 wt. %, or about 2 to about 25 wt. % of the organic solvent. In many embodiments, the aqueous firefighting foam composition includes an organic solvent including one or more of an alkylene glycol, glycerol, and a glycol ether. The alkylene glycol typically includes propylene glycol and/or ethylene glycol. The glycol ether typically includes ethylene glycol monoalkyl ether, diethylene glycol monoalkyl ether, dipropylene glycol monoalkyl ether, triethylene glycol monoalkyl ether, and 1-butoxyethoxy-2-propanol. In some embodiments, the organic solvent may be a mixture of an alkylene glycol and a glycol ether. In some embodiments, the organic solvent may be a mixture of glycerin and a glycol ether. In some embodiments, the organic solvent may be a mixture of propylene glycol and a glycol ether. In such embodiments, the organic solvent includes the alkylene glycol and glycol ether in a weight ratio of about 0.1:1 to about 10:1 or about 0.2:1 to about 5:1. In some embodiments, the organic solvent may be a mixture of glycerin and diethylene glycol monobutyl ether. In some embodiments, the organic solvent may include about 1 to about 20 wt. % and often about 1 to about 15 wt. % of alkylene glycol, such as ethylene glycol, or glycerin together with about 1 to about 15 wt. % and often about 1 to about 10 wt. % of a glycol ether, such as diethylene glycol monobutyl ether.

In some embodiments, the aqueous fluorine-free, fire-fighting foam composition includes a thickener that is not diutan gum. Non-limiting examples of the thickener include agar, sodium alginate, propylene glycol alginate, pectin, carrageenan, collagen, gelatin, sodium acrylate, xanthan gum, guar gum, tara gum, acacia gum, karaya gum, pullulan gum, locust bean gum, welan gum, rhamsam gum, chicle gum, kino gum, dammar gum, mastic gum, spruce gum, gellan gum, cassia gum, fenugreek gum, ghatti gum, konjac gum, gum arabic, gum guaicum, neem gum, gum tragacanth, gum chatti, tamarind seed, tapioca starch, cassava root powder, Pistacia lentiscus, caranna, galactomannan, beta-glucan, cellulose, methylcellulose, glucomannan, succinoglycan, hydroxyethylcellulose, hydroxypropylmethylcellulose, or a mixture of any two or more thereof. In some embodiments, the aqueous fluorine-free fire-fighting foam composition includes about 0.1 to 5 wt. % of the thickener. In some embodiments, the aqueous fluorine-free fire-fighting foam composition includes about 1 to 5 wt. %, 3 to 5 wt. %, 0.1 to 3 wt. %, or 0.1 to 1 wt. % of the thickener. In some embodiments, the aqueous fluorine-free fire-fighting foam composition includes about 0.1 wt. %, about 0.5 wt. %, about 1 wt. %, about 2 wt. %, about 3 wt. %, about 4 wt. %, or about 5 wt. % of the thickener.

In some embodiments, aqueous firefighting foam compositions of the present disclosure are substantially free of any polysaccharide thickeners. As used herein, the “phrase substantially free of polysaccharide thickeners” means that the aqueous firefighting foam composition includes no more than 0.1 wt. % polysaccharide thickener(s). In some instances, no more than 0.01 wt. % polysaccharide thickener(s).

In some embodiments, the present aqueous firefighting foam composition may include an alkanolamine, which can act as a pH adjusting agent and/or buffer. Suitable alkanolamines comprise monoethanolamine, diethanolamine, diisopropanolamine, and/or triethanolamine. In some embodiments, the present compositions may include triethanolamine. The triethanolamine may be present in only a relatively small amount, e.g., about 0.1 to 0.3 wt. % when included primarily as a pH adjusting agent. In other instances, the alkanolamine may be present in a higher amount, whether introduced per se as an ingredient and/or in the form of a cation as part of one of the surfactants present in the composition. In such instances, an alkanolamine, such as triethanolamine, may suitably be present as about 2 to 10 wt. %, about 3 to 10 wt. %, about 3 to 8 wt. %, and in some instances, about 3 to 7 wt. % of the composition.

As discussed above, the aqueous firefighting foam composition includes water. In some embodiments, the water is water from a municipal water source (e.g., tap water). In some embodiments, the water is a purified water, such as purified water that meets the standards set forth in the United States Pharmacopeia, which is incorporated by reference herein in relevant part. In some embodiments, the aqueous firefighting foam composition includes at least about 25 wt. % water, at least about 30 wt. % water, or at least about 35 wt. % water. In some embodiments, the aqueous firefighting foam composition includes up to about 60 wt. % or even 65 wt. % water. In some embodiments, the aqueous firefighting foam composition may desirably be produced using a source of water that has a total concentration of fluorine atoms on a weight percentage basis of no more than about 1 ppm F.

The aqueous firefighting foam compositions of the present disclosure are substantially free of fluorine. In some embodiments, the composition has a total concentration of fluorine atoms of less than 0.01 wt. %. In some embodiments, the composition has a total concentration of fluorine atoms of less than 0.005 wt. %. In some embodiments, the composition has a total concentration of fluorine atoms on a weight percentage basis of no more than about 70 parts per trillion (ppt) F. The aqueous firefighting foam compositions of the present disclosure may include substantially less than 70 ppt F. In some embodiments, the total concentration of fluorine in the aqueous firefighting foam composition is below detection limits.

In some embodiments, the aqueous firefighting foam composition may include one or more chelators or sequestering buffers. Illustrative and non-limiting chelators and sequestering buffers include agents that sequester and chelate metal ions, including polyamminopolycarboxylic acids, ethylenediaminetetraacetic acid, citric acid, tartaric acid, nitrilotriacetic acid, hydroxyethylethylenediaminetriacetic acid, and salts thereof. Illustrative buffers include phosphate and citrate buffers.

In some embodiments, the aqueous firefighting foam composition may include one or more corrosion inhibitors. Illustrative and non-limiting corrosion inhibitors includes ortho-phenylphenol, tolyltriazole, and phosphate ester acids. In some embodiments, the corrosion inhibitor is tolyltriazole.

In some embodiments, the aqueous firefighting foam compositions may also include a metallic salt, typically a metallic salt which includes a multi-valent cation. For example, suitable salts may include a cation selected from the group consisting of aluminum, calcium, copper, iron, magnesium, potassium, and calcium cations. The counter anion may suitably be a sulfate, acetate and/or phosphate anion. In some embodiments, the metallic salt is potassium bicarbonate. In one embodiment, the metallic salt may include a divalent salt, e.g., a magnesium salt, such as magnesium sulfate or magnesium acetate. When included, the metallic salt, such as magnesium sulfate or potassium bicarbonate, may suitably be present as about 0.1 to 5 wt. %, about 0.2 to 3 wt. %, about 0.5 to 3 wt. % and in some instances, about 0.5 to 2 wt. % of the composition.

In some embodiments, the aqueous firefighting foam compositions may also include a preservative, such as one or more antimicrobial additives and/or biocidal additives. These components are included to prevent the biological decomposition of natural product based polymers that are incorporated as polymeric film formers (e.g., a polysaccharide gum). Examples include Kathon CG/ICP (Rohm & Haas Company), Givgard G-4 40 (Givaudan, Inc.), Dowicil 75 and Dowacide A (Dow Chemical Company). In some instances, the biocidal agent in the present composition may include a phenol-based biocide, such as Dowacide A (sodium o-phenylphenate).

Tables 1 to 5 below provide an illustration of suitable formulations of the present firefighting foam compositions designed to be combined with a diluent, then aerated and administered to fight a fire in the form of a firefighting foam.

TABLE 1

| | Amount |
|---|---|
| Ingredient | (wt. %) |
| Biocide | 0-0.3 |
| Corrosion inhibitor | 0-0.2 |
| Zwitterionic surfactant | 2-15 |
| Anionic surfactant | 3-15 |
| Nonionic surfactant | 2-15 |
| Water-miscible organic solvent | 1-30 |
| Divalent metal salt | 0-5 |
| Sugar component | 5-25 |
| Water | 30-80 |

TABLE 2

| | Amount |
|---|---|
| Ingredient | (wt. %) |
| Biocide | 0-0.3 |
| Corrosion inhibitor | 0-0.2 |
| Alkyl sulfate anionic surfactant | 3-15 |
| Alkyl amidoalkyl hydroxysultaine | 3-15 |
| Alkyl polyglucoside nonionic surfactant | 2-15 |
| Glycol ether solvent | 1-20 |
| Polyol solvent | 1-20 |
| Alkanolamine | 0.1-10 |
| Divalent metal salt | 0-5 |
| Monosaccharide sugar(s) and/or sugar alcohol(s) | 5-20 |
| Water | 25-75 |

TABLE 3

| | Amount |
|---|---|
| Ingredient | (wt. %) |
| Biocide | 0-0.3 |
| Corrosion inhibitor | 0-0.2 |
| C₈₋₁₄-Alkyl amidopropyl hydroxysultaine | 2-12 |
| C₁₀₋₁₂-Alkyl sulfate surfactant | 5-15 |
| Alkyl polyglucoside nonionic surfactant | 2-15 |
| Alkylene glycol | 0-20 |
| Glycol ether | 0-20 |
| Glycerin | 0-20 |
| Triethanolamine | 0.1-10 |
| Magnesium salt | 0.2-3 |
| Sugar component | 5-25 |
| Water | 25-65 |

TABLE 4

| | Amount |
|---|---|
| Ingredient | (wt. %) |
| Biocide | 0-0.3 |
| Corrosion Inhibitor | 0-0.2 |
| Cocamidopropyl hydroxysultaine | 3-10 |
| Decyl and/or lauryl sulfate surfactant | 5-12 |
| Alkyl polyglucoside nonionic surfactant | 2-15 |
| Glycerin | 0-20 |
| Ethylene glycol | 0-20 |
| Diethylene Glycol Monobutyl Ether | 0-20 |
| Triethanolamine | 0.1-7 |
| Magnesium sulfate | 0.2-3 |
| Sugar component | 5-25 |
| Water | 25-65 |

TABLE 5

| | Amount |
|---|---|
| Ingredient | (wt. %) |
| Biocide | 0-0.3 |
| Corrosion inhibitor | 0-0.2 |
| Sugar component | 5-25 |
| Zwitterionic surfactant | 2-15 |
| Anionic surfactant | 5-25 |
| Nonionic surfactant | 0-15 |
| Water-miscible organic solvent | 1-30 |
| Metallic salt | 0-5 |
| Water | 25-65 |

### Examples

The following examples more specifically illustrate formulations for preparing aqueous firefighting compositions according to various embodiments described above. These examples should in no way be construed as limiting the scope of the present technology.

Table 6 shows the composition of illustrative formulations of the present aqueous firefighting foam composition. The amounts shown in the table represent the weight percentage of the particular component based on the total weight of the composition. The formulations include a) an anionic surfactant, b) a zwitterionic surfactant, c) organic solvent comprising an alkylene glycol, glycerol, and a glycol ether, d) a sugar component including a monosaccharide sugar, a disaccharide sugar, and/or a sugar alcohol, and e) a substantial amount of water. These illustrative formulations also include a divalent metal, such as a magnesium salt (e.g., magnesium sulfate). The illustrative formulations also include an alkanolamine, such as triethanolamine. These illustrative formulations may also include a preservative, an antimicrobial, and/or a corrosion inhibitor, though these ingredients are considered optional, and are not key to the composition functioning as a fire-fighting agent.

TABLE 6

| Component | Ex. A | Ex. B | Ex. C | Ex. D |
|---|---|---|---|---|
| Cocamidopropyl | 8.0 | 5.0 | 6.0 | 5.0 |
| Hydroxysultaine | | | | |
| Decyl Sulfate | 8.0 | — | 8.0 | — |
| TEA Lauryl Sulfate | — | 8.6 | — | 9.0 |
| TEA* | 5.0 | ~4.0* | 5.0 | ~4.0* |
| Ethylene glycol | 5.0 | 5.0 | 4.0 | 6.0 |
| Diethylene glycol monobutyl | 7.0 | 7.0 | 8.0 | 6.0 |
| ether | | | | |
| Glycerin | ~0.8 | ~0.5 | ~0.6 | ~0.5 |
| Glucose/fructose | ~13.5 | ~13.5 | ~14 | ~15 |
| Mg Sulfate | 0.6 | 0.6 | 0.7 | 0.6 |
| Preservative | 0.1 | 0.1 | 0.1 | 0.1 |
| Tolyltriazole | 0.05 | 0.05 | 0.05 | 0.05 |
| Water | ~51 | ~57 | ~53 | ~53 |

*—includes triethanolamine (TEA) from the TEA lauryl sulfate surfactant

Table 7 below shows the composition of illustrative formulations of the present aqueous firefighting foam composition. The amounts shown in the table represent the weight percentage of the particular component based on the total weight of the composition. The formulations include: a) an anionic surfactant, b) a zwitterionic surfactant, c) an organic solvent, d) a sugar component including a monosaccharide sugar, a disaccharide sugar, and/or a sugar alcohol, e) water, and f) a nonionic surfactant. These illustrative formulations also include a metallic salt, such as a magnesium salt (e.g., magnesium sulfate) or a potassium salt (e.g., potassium bicarbonate). The illustrative formulations also include an alkanolamine, such as triethanolamine. These illustrative formulations may also include a preservative, an antimicrobial, and/or a corrosion inhibitor, though these ingredients are considered optional, and are not key to the composition functioning as a fire-fighting agent.

| Component | Ex. E | Ex. F | Ex. G | Ex. H | Ex. I |
|---|---|---|---|---|---|
| Tolytriazole | 0.1 | 0.05 | 0.05 | — | 0.05 |
| Biocide | 0.25 | — | 0.05 | 0.05 | 0.05 |
| TEA-Lauryl Sulfate | 22 | 6 | 6 | 6 | 12 |
| Decyl Sulfate | — | 6 | 6 | 6 | 2 |
| Octyl Sulfate | — | 6 | 6 | — | 4 |
| Lauramidopropyl Betaine | 11 | 6 | 6 | 6 | 6 |
| Alkylpolyglucoside | — | 6 | 6 | 6 | — |
| Sugar component | 20 | — | 15 | 15 | 20 |
| Glycerin | — | 16 | 16 | 16 | — |
| Diethylene glycol | 10 | 10 | 8 | 10 | 1 |
| butyl ether | | | | | |
| Mg Sulfate | 1.25 | — | — | — | — |
| Potassium bicarbonate | 0.25 | — | — | — | — |
| Triethanolamine | — | — | — | — | 0.50 |
| Water | ~35 | ~44 | ~31 | ~35 | ~55 |

The present illustrative aqueous firefighting foam compositions, including the aqueous firefighting foam formulations shown in Tables 1-7, typically have a pH of about 6.5 to 8. If necessary, a pH-adjusting agent may be added to the composition to achieve the desired pH range.

### Method of Producing a Firefighting Foam

The firefighting foam compositions described herein may be mixed with a diluent to form firefighting foam precursor solution, i.e., a use strength composition. The firefighting foam precursor solution may be aerated (e.g., using a nozzle) to produce a firefighting foam including the firefighting foam composition and the diluent. Illustrative diluents may include water, such as fresh water, brackish water, sea water, and combinations thereof. In some embodiments, the firefighting foam compositions described above may be 1 vol. %, 3 vol. %, or 5 vol. % concentrate solutions, meaning that the firefighting foam compositions are mixed with 99 vol. %, 97 vol. %, or 95 vol. % diluent, respectively, to form the firefighting foam precursor solution.

### Method of Fighting a Fire

The firefighting foam compositions described herein may be used to fight a Class B fire and/or to suppress flammable vapors by mixing the firefighting foam compositions with a diluent to form a foam precursor, aerating the resulting firefighting foam precursor solution to form a firefighting foam, and administering the firefighting foam to a fire or applying the firefighting foam to the surface of a volatile flammable liquid (e.g., gasoline or other flammable hydrocarbon or a flammable polar solvent).

While certain embodiments have been illustrated and described, it should be understood that changes and modifications can be made therein in accordance with ordinary skill in the art without departing from the technology in its broader aspects.

The embodiments illustratively described herein may suitably be practiced in the absence of any element or elements, limitation or limitations, not specifically disclosed herein. Thus, for example, the terms “comprising,” “including,” “containing,” shall be read expansively and without limitation. Additionally, the terms and expressions employed herein have been used as terms of description and not of limitation, and there is no intention in the use of such terms and expression of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

Additionally, where features or aspects of the disclosure are described in terms of Markush groups, those skilled in the art will realize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof.

What is claimed is:

1. An aqueous fluorine-free, fire-fighting foam composition comprising:
a sugar component comprising a monosaccharide sugar, a disaccharide sugar, a sugar alcohol, or a mixture of any two or more thereof;
a nonionic surfactant comprising an alkyl polyglycoside, an aliphatic alcohol, or a mixture of any two or more thereof;
optionally, a second surfactant component comprising an anionic surfactant, a zwitterionic surfactant, or a mixture of any two or more thereof; and
a water-miscible organic solvent;
wherein the composition is substantially free of a polysaccharide thickener.

2. The aqueous fluorine-free, fire-fighting foam composition of claim 1, wherein the sugar component comprises glucose, fructose, mannose, xylose, sucrose, lactose, maltose, lactulose, trehalose, cellobiose, chitobiose, xylitol, sorbitol, mannitol, or a mixture of any two or more thereof.

3. The aqueous fluorine-free, fire-fighting foam composition of claim 1, comprising the anionic surfactant as the second surfactant component, wherein the anionic surfactant comprises an aliphatic sulfate surfactant, an aliphatic sulfonate surfactant, an aliphatic succinate salt, an aliphatic ether sulfate surfactant, or a mixture of any two or more thereof.

4. The aqueous fluorine-free, fire-fighting foam composition of claim 1, comprising the zwitterionic surfactant as the second surfactant component, wherein the zwitterionic surfactant comprises an aliphatic amidoalkyl betaine, an aliphatic sulfobetaine, an aliphatic amidoalkyl hydroxysultaine, an aliphatic hydroxysultaine, or a mixture of any two or more thereof.

5. The aqueous fluorine-free, fire-fighting foam composition of claim 1, wherein the water-miscible organic solvent comprises an alkylene glycol, an alkylene glycol monoalkyl ether, or a mixture of two or more thereof.

6. The aqueous fluorine-free, fire-fighting foam composition of claim 1, further comprising an alkanolamine.

7. The aqueous fluorine-free, fire-fighting foam composition of claim 1, further comprising a metallic salt.

8. The aqueous fluorine-free, fire-fighting foam composition of claim 1, further comprising a chelator, a buffer, a corrosion inhibitor, a preservative, or a mixture of any two or more thereof.

9. The aqueous fluorine-free, fire-fighting foam composition of claim 1 having a pH of about 6.5 to 8.

10. The aqueous fluorine-free, fire-fighting foam composition of claim 1 having a total of no more than about 0.01 wt. % fluorinated additives.

11. The aqueous fluorine-free, fire-fighting foam composition of claim 1 comprising a total of no more than about 0.01 wt. % of a polysaccharide thickener.

12. An aqueous fluorine-free, fire-fighting foam composition comprising:
about 5 to 25 wt. % of a sugar component comprising a monosaccharide sugar, a disaccharide sugar, a sugar alcohol, or a mixture of two or more thereof;
about 5 to 25 wt. % of an anionic surfactant;
about 2 to 15 wt. % of the zwitterionic surfactant;
about 1 to 30 wt. % of a water-miscible organic solvent; and
about 2 to 15 wt. % of a nonionic surfactant comprising an alkyl polyglycoside, an aliphatic alcohol, or a mixture of any two or more thereof;
wherein the composition is substantially free of a polysaccharide thickener.

13. The aqueous fluorine-free, fire-fighting foam composition of claim 12 comprising at least about 30 wt. % water.

14. A method of forming a firefighting foam, the method comprising aerating a foam precursor composition comprising the aqueous fluorine-free, fire-fighting foam composition of claim 1 to form the firefighting foam.

15. A method of forming a firefighting foam, the method comprising:
mixing the firefighting foam composition of claim 1 with an aqueous diluent to form a foam precursor solution; and
aerating the foam precursor solution to form the firefighting foam.

16. The method of claim 15, wherein the aqueous diluent is selected from the group consisting of fresh water, brackish water, sea water, and a combination of any two or more thereof.

17. The method of claim 15, wherein the aqueous diluent comprises water from a municipal water source.

18. A firefighting foam comprising
an aqueous diluent; and
an aqueous fluorine-free, fire-fighting foam composition comprising:
a sugar component comprising a monosaccharide sugar, a disaccharide sugar, a sugar alcohol, or a mixture of any two or more thereof;
a nonionic surfactant comprises an alkyl polyglycoside, an aliphatic alcohol, or a mixture of any two or more thereof;
optionally, a second surfactant component comprising an anionic surfactant, a zwitterionic surfactant, a nonionic surfactant, or a mixture of any two or more thereof; and
a water-miscible organic solvent; and
wherein the composition is substantially free of a polysaccharide thickener.

19. A method of fighting a fire comprising applying the firefighting foam of claim 18 to the fire.
